(19) United States
(12) Patent Application Publication
(10) Pub. No.: US 2007/0125220 A1
(43) Pub. Date: Jun. 7, 2007

(54) Guitar cord anchor

(76) Inventor: Kevin Ray Taylor, Okmulgee, OK (US)

Correspondence Address: Kevin Ray Taylor, 1313 East First Apt B, Okmulgee, OK, 74447, US

(21) Appl. No.: 11/295,092

(22) Filed: Dec. 6, 2005

(51) Int. Cl. G10D 3/00

(52) U.S. Cl. 84/290

(57) ABSTRACT

An improved dual-functioning guitar cord anchoring device intended to prevent an unintentional disconnection of a guitar cord from a jack through proper securing of the guitar cord, and to decrease the chance of stepping on the guitar cord through redirecting thereof. The guitar cord anchor is comprised of a durable single-piece construction, made of a resilient spring steel wire. Having a tapered clasp to accommodate a strap stud of variant size, and which also eliminates the need to remove any existing guitar parts for installation and transfer. A superior gripping series of helical loops, which completely encompasses the circumference of a portion of the guitar cord.

### BACKGROUND OF THE INVENTION

1. Field of the Invention

The present invention pertains to guitar accessories, a device that secures a guitar cord to the body of a guitar.

2. Description of Prior Art

There have been previous attempts by various inventors to design a device which will prevent an unintentional disconnection of a cord from a guitar. Although these prior art devices are functional to some degree, they do also have many inherent design inefficiencies as well, and lack certain features which are necessary for an optimal performance. The following paragraphs are examples of patents which contain such unfavorable attributes.

U.S. Pat. No. 6,198,031 issued to Jones which discloses a cable lock device in the form of a J-shaped strip with a small mounting hole. The design of this device neglects to meet various requirements necessary in order to be considered as high-quality.

For example, in order to implement this device the user must first perform an inconvenient installation procedure, which includes the removal of an existing strap stud. This procedure can likely be viewed by many guitarists as bothersome and intrusive, to say the least. Once this prior art device is installed, it is practically a permanent fixture of the guitar by disallowing a quick and easy removal and transfer to another guitar. Another disadvantage of this device is that it is quite rigid, lacking any yielding quality necessary to prevent damage to the cord due to tension in the event of a harsh pull on the cord.

A further disadvantage with this device is its U-shaped cord channel, which only partially encompasses the cord, thereby allowing an opportunity for possible slippage and displacement of the cord.

U.S. Pat. No. 5,145,399 issued to Davenport discloses a multiple-parts cable lock comprised of a mounting plate, a support leg, an abutment sleeve, a cable boss, and a bumper ring.

A major disadvantage of this device is it is comprised of multiple parts. Having multiple parts means a more involved manufacturing effort, which substantially increases the cost of the product. Also, such a device that has multiple parts has multiple weaknesses, increasing the possibilities of malfunction.

This device also presents an excessively time-consuming and troublesome installation procedure. Once installed, like the previous example device, it becomes a permanent fixture of the guitar, which is not very desirable to most guitarists.

Another disadvantage with this device is that it is installed at the guitar jack, most commonly located at the lowermost region of the guitar body, which allows the guitar cord to drop directly downward and lay essentially at the guitarist's feet. Although the device may prevent the cord from disconnecting with the guitar, it does not do anything to prevent the cord from getting stepped on.

U.S. Pat. No. 4,357,063 issued to Gray discloses a multiple-part cord anchoring device comprised of an enlarged washer, a locking plate, a detachable hook, a resilient connector tension member, and a permanently attached cord fitting. Again, this is another device that is composed of multiple parts, driving up its cost and increasing the likelihood of malfunction.

Furthermore, this device requires the initial assembly of its locking plate into its

### BACKGROUND OF THE INVENTION

Description of Prior Art receiving member. This assembly procedure is most likely performed during the manufacturing process, amounting to additional costs of time and money.

Another disadvantage is that once the device is installed, it is permanently attached to the guitar cord via its permanently attached cord fitting. As previously discussed, the permanent mounting of such a device to either the guitar or its associated equipment is likely to be disagreeable to most guitarists.

The need for a new and better device that accommodates all aspects of manufacturing and consumer usage still remains.

### SUMMARY OF THE INVENTION

Ordinarily, during normal use, a portion of the guitar cord can be found lying near the feet of the guitarist. This creates a potential for getting stepped on, and a consequential likelihood of becoming unplugged from the guitar. This unfortunate occurrence will undoubtedly cause an undesirable interruption of the musical performance.

Typically, upon this event, an initial pop is followed with a humming sound produced through the guitar amplifier. The guitarist will have to quickly turn off the amplifier to prevent any further unwanted noise. The guitar cord will then have to be retrieved from off the floor, reinserted into the guitar cord jack, and the amplifier turned back on in order to resume the performance, causing an inconvenience and possibly an embarrassing situation for the guitarist.

It is important to consider many things when contemplating the design of the present invention. For instance, it is a popular and common practice during a performance for the guitarist to utilize multiple guitars, exchanging one for another to suit any particular musical piece. Considering this, the general idea of the present invention is to create a simple device which will not only prevent such an aforementioned undesirable event from occurring, but also make it conveniently possible to use a single device for multiple guitars, therefore saving the guitarist much trouble and money by eliminating the necessity of multiple devices.

The new and present invention will be made of an easily obtainable, non-specialized general-purpose, spring-tempered steel wire. The device can be readily formed from wire directly off the spool, without any intermediating alterations of the factory-formed material; from raw material to finished product in essentially one step, presenting an enormous advantage over all prior art.

The spring-tempered steel wire is idealistically suited for the new and present invention because of its excellent resiliency property, which will allow it to give in to tension due a pull on the cord during usage, thereby retain its original shape and promote an extended lifetime of use.

The new and present invention will consist of a single part, minimizing manufacturing cost, thereby allowing the device to be economically available to the consumer. The single-part construction will also ensure a durable and reliable life expectancy.

The new and present invention will provide convenience of use by means of a novel tapered clasp. This clasp is to be used in conjunction with a portion of the cord itself in order to accommodate and fully capture an existing strap stud of variant size. The tapered clasp will provide for a quick installation without necessitating the removal of any existing guitar parts, namely including the strap stud.

The new and present invention will provide a most effective gripping action by means of a novel series of helical loops, in which the guitar cord can be wrapped a full 360 degrees, providing for a superior security of the cord, in contrast to prior art which only provides a partial wrap.

Unlike any prior art, the new and present invention will utilize a rubberized or similarly pliable protective coating, applied to the helical loops in order to further maximize its gripping action, and enhance protection against possible damage to the cord due to a harsh pull.

Up until now, prior art devices necessitated the removal of some guitar parts to achieve installation. Therefore, it is a principal object of the present invention to provide a convenient non-modifying and non-intrusive installation including the non-removal of any existing guitar parts, allowing for a quick and easy transfer of the device from one guitar to another.

### SUMMARY OF THE INVENTION

It is another object of the present invention to relocate the placement of the guitar cord from normally in front of the guitarist's feet to outside the footpath. This can be easily achieved by installing the guitar cord anchor to an outermost boundary of the guitar body. This redirecting of the guitar cord will decrease the probability of stepping on the cord, thereby allowing the guitarist to walk back and forth freely, substantially reducing the burdensome avoidance of stepping on the cord.

Another object of the present invention is to consist of a simple single-piece construction, allowing for quick mass production, durability and reliability.

Another object of the present invention is to maintain a low manufacturing cost of the guitar cord anchor by consisting of inexpensive, readily-available material.

It is a further object of the present invention to create an adaptable and versatile guitar cord anchor, which can be instantly implemented on virtually any guitar.

Yet another object of the present invention is to create a guitar cord anchor that presents no harm to the user, or guitar, or associated equipment.

Still another object of the present invention is to create a most effective guitar cord anchor by providing maximum security of cord placement.

Additional objects of the present invention is to provide peace of mind to the guitarist by preventing an inconvenient and potentially embarrassing situation, and promote a sleek and professional image through cord tidiness.

These and other objects and advantages of the present invention will become readily apparent upon further review of the following specification and drawings.

### BRIEF DESCRIPTION OF THE DRAWINGS

FIG. 1 shows a frontal view of the guitar cord anchor with its various features including a downward angular slope, of approximately 36 degrees, of the series of helical loops on either half.

FIG. 2 shows a frontal view of the guitar cord anchor properly attached onto the guitar cord.

FIG. 3 shows a frontal view of the guitar cord anchor along with the attached guitar cord properly installed onto the guitar body via existing strap stud.

FIG. 4 shows a top view along with various features of the properly installed guitar cord anchor including the stop placement, and an angular deflection, of approximately 36 degrees, of the series of helical loops away from the guitar body.

### DETAILED DESCRIPTION OF THE INVENTION

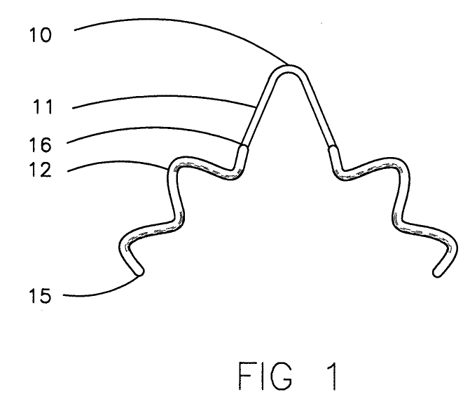

A length of approximately 6 inches of spring-tempered steel wire of approximately 15 gauge is curved to form a center 10 of a guitar cord anchor with an approximate ⅛ inch radius, and producing an angle of approximately 36 degrees. The wire is extended outwardly from the curve of the radius, creating a tapered clasp 11 with an approximate ⅝ inch spread, shown best in FIG. 1.

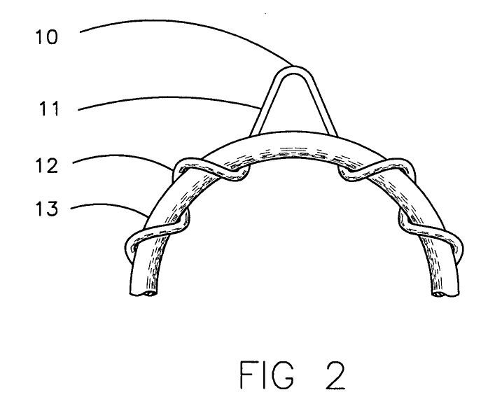

A series of helical loops 12, containing at least 1 loop but preferably 2 or more loops, are formed on each side of tapered clasp 11, comprising a radius of approximately 5/32 inch. Each series of helical loops 12 are diagonally sloped on a downward angle of approximately 36 degrees in reference to a level horizon, also shown best in FIG. 1. Series of helical loops 12 are spaced apart adequately and sufficiently enough for a guitar cord 13 of common size, as shown in FIG. 2, to easily fit between without stressing, excessively bending, or damaging guitar cord during installation.

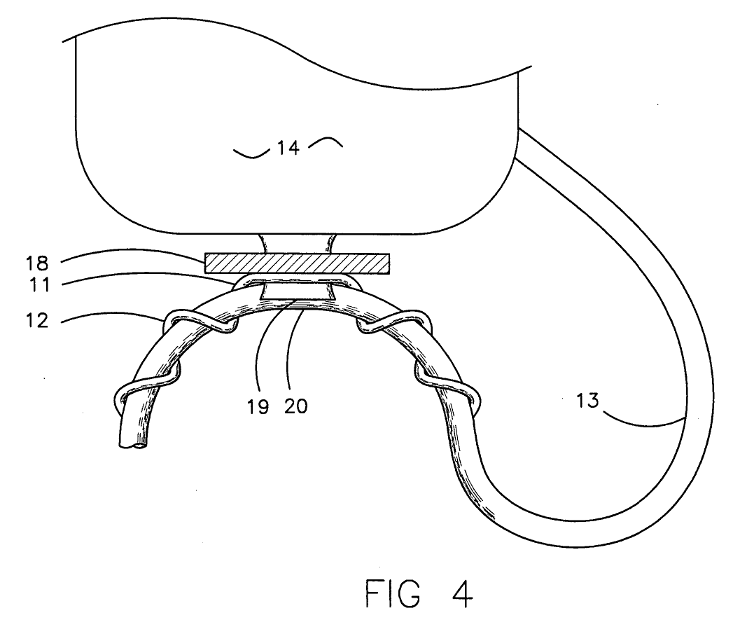

Each series of helical loops 12 form an additional angular deflection of approximately 36 degrees in an outwardly direction away from a guitar body 14, as shown in FIG. 4, in order to avoid contact of either series of helical loops with guitar body during implementation.

An end 15 is made smooth and devoid of any sharp or jagged edges to prevent any personal injury or damage to surrounding objects. Lastly, series of helical loops 12 and lower portion of tapered clasp 11 are layered with a pliable coating 16, as shown in FIG. 1, to finalize and complete the manufacturing process.

To install guitar cord anchor, first a location on guitar cord 13, approximately 12 inches from a cord plug 17, is selected as the site of the installation. The exact location may vary according to the preference of an individual guitarist. Guitar cord 13 is then wound consecutively onto series of helical loops 12, between each and every loop and in a correspondingly similar direction to, beginning with the loop nearest to tapered clasp 11, working outwardly to end 15 until each loop is utilized. Guitar cord anchor is now securely mounted to guitar cord 13 as shown in FIG. 2, and ready to be installed onto guitar body 14.

Guitar body 14 is commonly supported by a strap 18, which extends over the guitarist's shoulder, and is securely fastened onto guitar body as shown in FIG. 4, by the use of a strap stud 19 at either extremity of strap. Guitar cord anchor is intended to be installed on the outermost boundary of guitar body 14 via strap stud 19, as shown in FIG. 4. This location is most effective for providing redirection of guitar cord 13 away from the footpath of the guitarist, therefore diminishing the possibility of stepping on guitar cord 13. Guitar cord anchor can be just as easily implemented with or without the use of strap 18, but in order to simplify the installation directions, strap is used.

To complete the installation, guitar body 14 is first situated in a common and standard upright playing position by employing the use of strap 18 across the shoulder. With the utilization of tapered clasp 11, guitar cord anchor along with the encompassed portion of guitar cord 13, is motioned downwardly and completely onto strap stud 19, positioning adjacent to and contiguous with strap 18, shown best in FIG. 4.

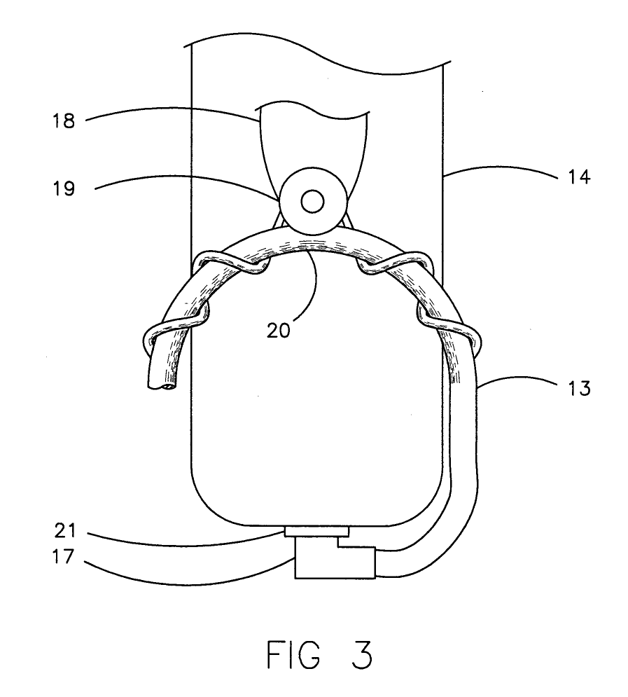

Guitar cord anchor is securely held in place with the assistance of a portion of guitar cord 13 called a stop 20. Stop 20 is placed underneath strap stud 19, also best shown in FIG. 4. The placement of stop 20 is what effectively maintains the properly installed positioning of guitar cord anchor, by disallowing an infrequent upward movement of device during usage. Guitar cord anchor is now completely installed and ready for use; just insert cord plug 17 into a jack 21 as usual as shown in FIG. 3.

As an unobvious feature, guitar cord anchor can be quickly and easily transferred onto a secondary guitar without the impeding removal of any existing guitar parts, eliminating the necessity of a separate device for each individual guitar. This is done simply by using one's finger to gently pull outwardly on stop 20 while lifting up on guitar cord anchor. While leaving guitar cord anchor attached to guitar cord 13, guitar cord anchor is quickly and easily removed from the original guitar body 14 and placed onto another guitar by using the same downward installment method as previously described. Guitar cord anchor can be completely uninstalled by a repetition of the installation procedure in a reversed order.

I claim:

1. A device for a guitar cord for anchoring and redirecting thereof, thereby preventing an accidental disconnection of said guitar cord from a guitar jack, comprising:
a series of helical loops which fully encompasses the circumference of said guitar cord, thereby providing superior grip and,
a tapered clasp which readily accommodates a strap stud regardless of the possible common size variations thereof, thereby avoiding the need of any modifications to a guitar body specifically including the removal of any parts thereof to achieve installment.

2. The device of claim 1 wherein said series of helical loops and said tapered clasp is made of a single solid wire possessing a stout yet yielding spring quality, thereby providing protection through flexibility, against potentionally damaging effects in the event of tension upon said guitar cord.

3. The device of claim 1 wherein said tapered clasp incorporates said guitar cord to be used in conjunction with, and by mutual positioning of both, to fully encompass and effectively capture said strap stud, thereby maintaining proper installation.

4. The device of claim 1 wherein said series of helical loops are spaced sufficiently enough apart to allow said guitar cord to pass in between.

5. The device of claim 4 wherein said series of helical loops measured inside diameter is approximately the same diameter as said guitar cord.

6. The device of claim 5 further including a pliable coating layered upon said series of helical loops and lower portion of said tapered clasp, thereby providing additional grip of said guitar cord, and thereby providing additional protection against potentially damaging effects in the event of tension upon said guitar cord.
